(19) United States
(12) Patent Application Publication
(10) Pub. No.: US 2016/0119615 A1
(43) Pub. Date: Apr. 28, 2016

(54) THREE DIMENSIONAL DATA VISUALIZATION

(71) Applicant: HEWLETT-PACKARD DEVELOPMENT COMPANY, L.P., Houston, TX (US)

(72) Inventors: Nelson L. Chang, San Jose, CA (US); Warren Jackson, San Francisco, CA (US)

(21) Appl. No.: 14/894,011

(22) PCT Filed: May 31, 2013
(86) PCT No.: PCT/US13/43761

§ 371 Date: Nov. 25, 2015

(51) Int. Cl. H04N 13/04; H04N 13/00

(52) U.S. Cl. CPC H04N 13/0495; H04N 13/0022; H04N 13/0037

(57) ABSTRACT

A technique to generate a three-dimensional (3D) data visualization from multi-dimensional data. A data set may be grouped into multiple groups based on a function. Data members of the groups may be mapped to respective 3D volumes via graphic elements. A value of the function for each data member may be mapped to at least one of the spatial display variables representing depth. A 3D data visualization including the 3D volumes may be generated.

### BACKGROUND

Data visualizations may be used to illustrate relationships between datasets. These visualizations may organize and present the data in a variety of ways to allow a viewer to better understand the data. Visualizations typically have practical limits regarding the amount of data that can be shown as well as constraints on the arrangement of data. A visualization that shows too much data, for example, may become visually cluttered and difficult for a viewer to process. Similarly, a visualization that includes too many different types of data may prevent relationships between the different types from being observed by the viewer.

### BRIEF DESCRIPTION OF DRAWINGS

The following detailed description refers to the drawings, wherein:

FIG. 1 illustrates a method of generating a 3D data visualization using disparity as a display variable, according to an example.

FIG. 2 illustrates a method of defining a position and size of 3D volumes, according to an example.

FIG. 3 illustrates a method of highlighting a group using disparity, according to an example.

FIGS. 4(a)-4(c) illustrates views of a 3D data visualization, according to an example.

FIG. 5 illustrates a system for generating a 3D data visualization using disparity as a display variable, according to an example.

FIG. 6 illustrates a computer-readable medium for generating a 3D data visualization using disparity as a display variable, according to an example.

### DETAILED DESCRIPTION

As described herein, a three-dimensional (3D) data visualization processing environment may use disparity as a fundamental variable to allow multi-dimensional data to be visualized with a 3D display system. As used herein, the term “disparity” refers to the difference in image location of an object seen by the left and the right eyes of a viewer. The effect of disparity in a visualization viewed in stereoscopic 3D may be to create the appearance of depth within the visualization. For example, certain objects in the visualization may appear to be popping out toward a viewer with respect to the screen/display surface, while other objects appear to be set back in the visualization (i.e., farther from the viewer).

According to an example, given a data set that includes multi-dimensional data, multiple groups may be defined based on a function of at least one variable of the multi-dimensional data. In some examples, data members of the multiple groups may overlap. Multiple 3D volumes corresponding to the multiple groups may be defined, such as based on dimensionality limits of the underlying data in each group. As used herein, the term “3D volume” refers to a portion of a 3D coordinate space (e.g., a point, a line, a plane, a polygonal volume) that is to be occupied by representations of data members in a respective group. In particular, for each group, graphic elements may be generated for a respective one of the 3D volumes from the data members of the group using spatial display variables and other display variables. The spatial display variables may include an x coordinate position, a y coordinate position, and a z coordinate position within the visualization as viewed in 3D. Examples of the other display variables are color, size, and orientation.

A value of the function for each data member may be mapped to at least one of the spatial display variables representing depth. What this means is that the function is mapped to the one or more spatial display variables intended to represent depth in the 3D visualization when viewed in 3D. For instance, if the visualization is intended to be displayed in perfect alignment with the x, y, and z axes relative to a viewer's position, the z axis would represent depth. Thus, the function would be mapped to the z axis. In other cases, due to the perspective of the viewer for example, another of the axes or a combination of the axes may represent depth. The perception/effect of depth is achieved for a stereoscopic 3D system through the use of disparity, which is the difference in image location of an object in a left and right image pair displayed on the stereoscopic 3D system.

A 3D data visualization may be generated that includes the 3D volumes and their corresponding graphic elements. As a result, the multiple groups may be perceived by a viewer as being at different depths within the visualization, Depending on the arrangement of the data, the multiple groups may appear to constitute different layers within the visualization.

The use of disparity in this way exploits human beings' innate binocular vision and stereopsis to allow viewers to perceive differences in depth between representations (e.g., the graphic elements) in the visualizations. These differences provide both focus and context to the viewer within the visualization so that the viewer may more readily recognize features in the data (e.g., patterns, trends, outliers, and corner cases), obtain insights into the data, and identify areas for further investigation in the data. The use of disparity along with other visual elements to represent dimensions/attributes of data members of a data set can allow for the rapid detection of particular data points and/or enable the recognition of insights. As a simple example, by grouping a set of vehicles by horse power rating, displaying that grouping in the 3D visualization using depth (via disparity), and representing other attributes of the vehicles using other display variables (e.g., color representing price, size representing size of the vehicle), one can quickly and easily pick a vehicle without detailed examination of each data point. Furthermore, a large amount of data may be included in the visualization and seen by the viewer all at once while maintaining sufficient spacing of the data and avoiding visual clutter. The presentation of data in 3D may also speed the recognition of data co-occurrences through the use of local 3D spatial patterns. Additional examples, advantages, features, modifications and the like are described below with reference to the drawings.

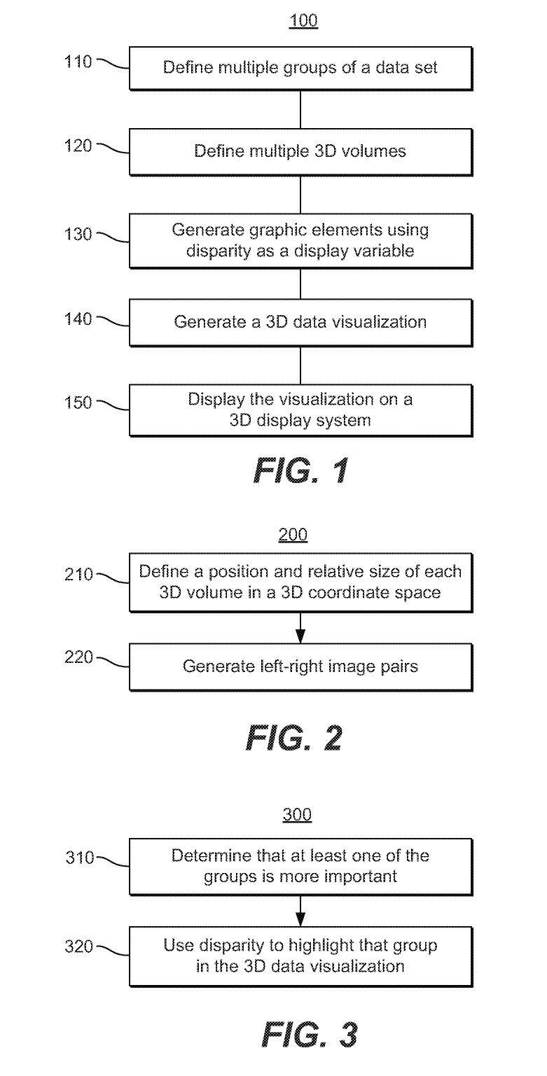

FIG. 1 illustrates a method of generating a 3D data visualization using disparity as a display variable, according to an example. Method 100 may be performed by a computing device, system, or computer, such as computing system 500 or computer 600. Computer-readable instructions for implementing method 100 may be stored on a computer readable storage medium. These instructions as stored on the medium are referred to herein as “modules” and may be executed by a computer.

Method 108 may begin at 110, where multiple groups of a data set may be defined. The data set may comprise multi-dimensional data. The data set may include structured and/or unstructured data that includes at least two variables. The data set may include multiple data members. The data members may come from one or more sources. For instance, one portion of the data set may include data from a social network (e.g., Facebook, LinkedIn), while another portion of the data set may include customer purchasing data, such as derived from a company's internal records. Additionally and relatedly, the data set may include heterogeneous data members, where the same variable may not be consistent across all data members. For example, one portion of the data set may include data members having variables A-E while a second portion of the data may include data members having variables D-M, such that only variables D and E are common between the two portions. This may be a common occurrence when the data set is drawn from multiple sources.

The multiple groups may be defined based on a function of at least one variable of the multi-dimensional data. The function may be any of various functions (e.g., identify function, clustering algorithm). In some cases, the multiple groups may be defined using more than one function. Thus, as used herein, “a function” may refer to “at least one function”.

Using more than one function to define the groups may be useful when grouping a data set containing heterogeneous data members. For example, given a data set with a first portion of data members including variables A-E and a second portion of data members including variables D-M, one function may be used to define the groups in the first portion based on one or more of variables A-E and a second function may be used to define the groups in the second portion based on one or more of variables D-M. As a simple example, in a data set containing a first portion comprising Facebook data for a customer and a second portion comprising purchasing data for the customer and the customer's friends, a first function may define groups in the first portion based on the number of interactions between the customer and the customer's friends while a second function may define groups in the second portion based on monetary value of purchases for each customer.

As another example, using more than one function to define groups may cause the multiple groups to have overlapping data members. For instance, given a homogeneous data set including data members each having variables A-M, a first set of groups may be defined using a first function and a second set of groups may be defined using a second function. As a result, the same data member may be grouped into one of the first set of groups and one of the second set of groups. As a simple example, in a data set including weblog data of multiple users, a subset of the multiple groups may be defined based on an average time spent on a website and another subset of the multiple groups may be defined based on a clustering of the users based on particular websites visited by the users.

At 120, multiple 3D volumes may be defined corresponding to the multiple groups. For example, a 3D volume may be defined for each group of the multiple groups, such that there are an identical number of 3D volumes as groups. A 3D volume is a portion of a 3D coordinate space, A 3D volume may be defined by x-, y-, and z-axis coordinates, which are referred to herein as spatial display variables. Accordingly, a 3D volume may be defined for a given group based on the dimensions of the variables of the data members in the given group.

The variables of the data members that are to be mapped to the spatial display variables may be determined in various ways. For example, the variables may be specified by a user generating the 3D data visualization, such as by configuring the 3D data visualization system via a user interface. Alternatively, the mapping may be based on a predetermined scheme.

At 130, graphic elements may be generated for each 3D volume. For example, for a given 3D volume, the graphic elements may be generated from data members of the corresponding group. In some examples, graphic elements may not be generated for all data members due to computation or rendering constraints (e.g., there is a limit to how many graphic elements may be displayed at one time by a 3D display system). The graphic elements may be generated using the spatial display variables and other display variables. The spatial display variables define the location of a graphic element within a 3D volume. Accordingly, the spatial display variables include an x-axis coordinate, a y-axis coordinate, and a z-axis coordinate. As will be discussed in more detail later, each 3D volume may have its own local 3D coordinate space separate from a global 3D coordinate space of the 3D data visualization.

The other display variables include features such as orientation, shape, color, and size of the graphic element. In the case of continuous 3D systems, time (i.e., changes in the visualization over time) may be used as a display variable. The other display variables may also include connections between graphic elements, which connections may be variable in length, thickness, color, position, and orientation. Each other display variable may be mapped to a particular variable of the data members in a group. These mappings may be defined in a similar fashion as the spatial display variables.

As previously mentioned, disparity may be specifically used as a display variable. Disparity refers to the difference in image location of an object seen by the left and the right eyes of a viewer. The effect of disparity in a visualization may be to create the appearance of layers within the visualization. For example, disparity may be used to influence the perception of depth in the visualization. For instance, certain objects in the visualization may appear to be popping out toward a viewer, while other objects appear to be set back in the visualization (i.e., farther from the viewer).

In method 100, disparity is used to highlight the groupings of the data set. Thus, a value of the function for each data member is mapped to at least one of the spatial display variables representing depth. The particular spatial display variables that will represent depth (that is, the spatial display variable that will provide the effect/illusion of depth within the 3D data visualization) depends on the perspective of the viewer. Thus, the expected position of the viewer may be considered so as to determine the expected perspective of the viewer, and thus which spatial display variable(s) should be used to represent depth. By performing this mapping between the function and depth, the multiple groups/3D volumes may be perceived by the viewer as different layers within the visualization. Of course, the delineation between layers may not be clean, as graphic elements of outlying data members in one 3D volume may be close to or even overlap graphic elements in another 3D volume.

At 140, a 3D data visualization may be generated, The 3D data visualization may include the 3D volumes and corresponding graphic elements. At 150, the visualization may be displayed on a 3D display system, such as 3D display 550 of computing system 500,

FIG. 2 illustrates a method 200 for generating the 3D data visualization, as performed at 140 of method 100. Method 200 may be performed by a computing device, system, or computer, such as computing system 500 or computer 600. Computer-readable instructions for implementing method 200 may be stored on a computer readable storage medium. These instructions as stored on the medium are referred to herein as “modules” and may be executed by a computer.

At 210, a position and relative size of each 3D volume may be defined in a 3D coordinate space. For example, the 3D coordinate space may be a global 3D coordinate space for the visualization. Thus, each 3D volume may have its own local 3D coordinate space for its graphic elements, while all of the 3D volumes may be plotted on the global 3D coordinate space. Accordingly, in some cases, a relative origin of one 3D volume may differ from a relative origin of another 3D volume. As an additional feature, defining the position of each 3D volume can include correlating one or more coordinate positions of graphic elements between 3D volumes based on a common value of a variable between data members.

For example, a data set may include social network data, such as Twitter data. The data set may include multiple data members, each data member representing a post (e.g., tweet). Each data member may include various information about the respective post, such as author, geographical location of the author, content, time stamp, etc. In one example, this data may be displayed using the techniques described herein in the following way. The graphic elements representing the data members may be spheres. The author's geographical location (2 dimensions) may be displayed via x-y location of the sphere. The time stamp (1 dimension) may be displayed via local depth within a layer. The sentiment (1 dimension) of content may be displayed as different colors. Influence/connectivity (1 dimension) of the author may be displayed via the size of the spheres. Additionally, the data members may be divided into groups via a function of at least one variable of the data. For example, the function may determine categories of the data members and thus group the data members by category. Category (1 dimension) may then be represented as different layers in the visualization through the use of disparity. As another example, groups of the 3D radial representations described in International Patent Application No. PCT/US13/27525, filed on Feb. 23, 2013, which is hereby incorporated by reference, may be mapped into the global 3D coordinate space, using disparity to display the groups as different 3D volumes.

The usable size of the 3D coordinate space may be constrained by certain constraints and thus may be considered an “available” 3D coordinate space. For example, the available 3D coordinate space may be constrained by characteristics of the 3D display system, such as a size of a 3D display screen, perceivable depth, rendering capability of the system, visibility, and expected user position relative to the 3D display screen.

A 3D data analysis may be performed by the 3D display system to determine an optimal amount of disparity to include for the 3D volumes. The 3D data analysis can evaluate the size and data ranges of the 3D volumes. Based on the analysis, the underlying data in a given 3D volume may be renormalized, scaled, or the like. Additionally, the number of graphic elements in a given 3D volume may be reduced to permit all 3D volumes to fit in the available coordinate space. By doing so, the 3D volumes and corresponding graphic elements can be selected and optimized to minimize overcrowding in the visualization and maximize the exploitation of human binocular vision and stereopsis.

At 220, left-right image pairs of the combined 3D volumes may be generated to yield two stereoscopic binocular views. For example, this can be done by a 3D data visualizer, which may be part of visualization generator 550. In particular, each image pair can be generated to include left and right images that are displayable by a 3D display system to produce a 3D viewpoint of the 3D data visualization. In particular, when the left and right image are displayed such that a viewer views the left image with his left eye and the right image with his right eye, the viewer may see stereoscopic 3D. Each image pair may be generated based on the type, size, and configuration of the 3D display system. Different images pairs may be generated to produce different 3D viewpoints with the same 3D display system simultaneously, Different images pairs may be generated to produce a succession of 3D viewpoints with the same 3D display system. This change in view point may help provide motion parallax as an additional depth cue to enhance the 3D effect if done in such a way to avoid viewer side effects. For multi-view and continuous 3D display systems, additional views may be generated for each image pair to provide one or more images for each view.

In some examples, a user/viewer can manipulate a visualization. The 3D data visualizer can receive inputs and generate image pairs to be displayed. The inputs can identify one or more updates to a 3D data visualization that allow a viewer to select, control, and manipulate data or the orientation of the 3D data visualization. The selection of data may cause changes to the representations of the 3D volumes and graphic elements in the visualization, for example. Inputs may be received from any suitable user interface device and may take the form of 3D gestures or other input modalities. Responsive to receiving the inputs, the 3D data visualizer can update the arrangement of axes, the 3D volumes, and/or the graphic elements and generate updated images pairs.

In some examples, the 3D data visualizer may add one, two, or three-dimensional visual guides to a 3D data visualization to assist a viewer with selecting or highlighting data (e.g., individual data members, groups) in the visualization. For example, partially transparent lines, surfaces, or shapes may be used to highlight data ranges in various visualizations.

In some examples, 3D data visualizer may make the 3D volumes and/or graphic elements time-varying by generating a series of image pairs for successive display to form a time-varying 3D data visualization. Additional information such as visually warbling items, oscillations, flow indicators and vapor trail effects may be used to highlight changes of selected data over time.

FIG. 3 illustrates a method 300 of drawing attention to a group using disparity, according to an example. Method 300 may be performed by a computing device, system, or computer, such as computing system 500 or computer 600. Computer-readable instructions for implementing method 300 may be stored on a computer readable storage medium. These instructions as stored on the medium are referred to herein as “modules” and may be executed by a computer.

At 310, it may be determined that at least one of the multiple groups is important. For example, one of the groups may be determined to be more important than the other groups due to one or more characteristics of the group, such as the size of the group. At 320, disparity may be used to draw attention to the particular group in the 3D data visualization. For example, the position of the 3D volume corresponding to the particular group may be defined so as to make the 3D volume more prominent through disparity. This can be accomplished by assigning to the 3D volume/group a depth in the 3D data visualization closer to an expected position of a viewer.

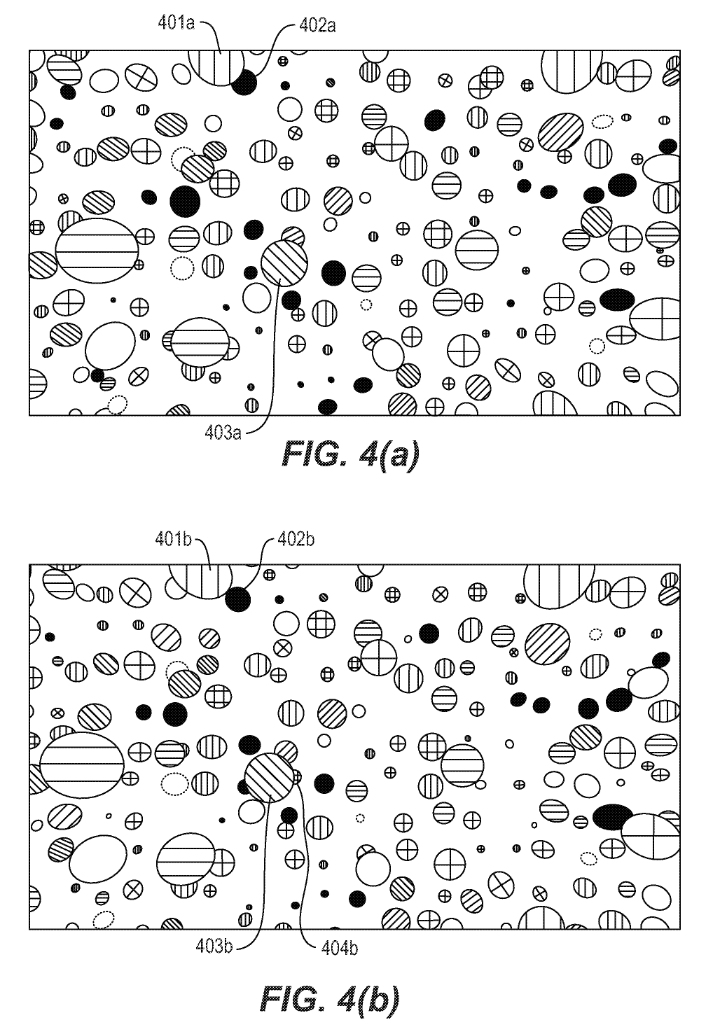

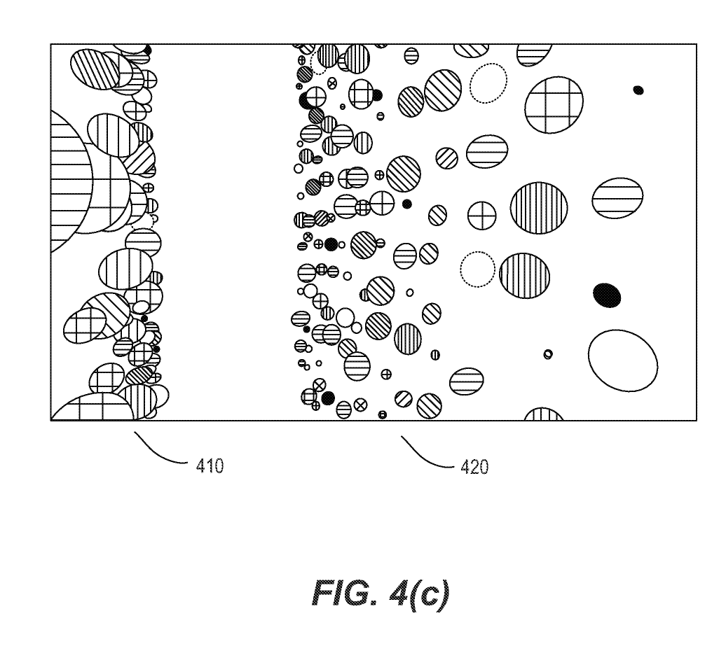

FIGS. 4(a)-(c) illustrates views of a 3D data visualization, according to an example. Looking at only a single 2D image, the relationships between the graphic elements depicted in the visualization may be difficult to discern since the colored balls are of varying sizes and shades (where shading patterns here are intended to represent color). However, when FIGS. 4(a) and 4(b), which are intended to constitute a left-right image pair, are perceived in stereoscopic 3D, a viewer can immediately notice that the data is actually organized into two distinct planar clusters. This effect is achieved through the use of disparity, which is the difference in image location of an object seen by the left and the right eyes of a viewer. Here, some of the objects in FIG. 4(b) are shifted relative to the position of those objects in FIG. 4(a). For example, object 401a partially overlaps object 402a in FIG. 4(a), while object 401b touches but does not overlap object 402b in FIG. 4(b). Similarly, object 403b partially overlaps object 404b in FIG. 4(b), while in FIG. 4(a) only object 403a can be seen due to object 403a completely overlapping/covering the object that corresponds to object 404b. This difference in positions between the objects in the two images is the disparity. To illustrate the effect of disparity in the 2D context here, FIG. 4(c) shows an oblique viewpoint to emphasize the separated/layered nature of the data. The two layers are indicated by reference numerals 410 and 420.

Moreover, the viewer can easily focus on the front plane of spheres and their connections (and even observe their local depth variations) when the images are viewed in stereoscopic 3D, and likewise switch focus to the back plane, all without getting overwhelmed or losing context, The openness of the rendering allows viewers to leverage the human visual system's natural ability to segment in disparity. It also helps to mitigate the number of occluded objects and reduce the need for the viewer to have to alter the viewpoint. As an example application, this type of visualization may be effective for depicting the relative relationships of graphic elements in one context/plane and correlating that to the graphic elements in a different context/plane. For instance, the front plane data may represent the context of a person's purchase influence and the back plane could represent the person's social connectivity.

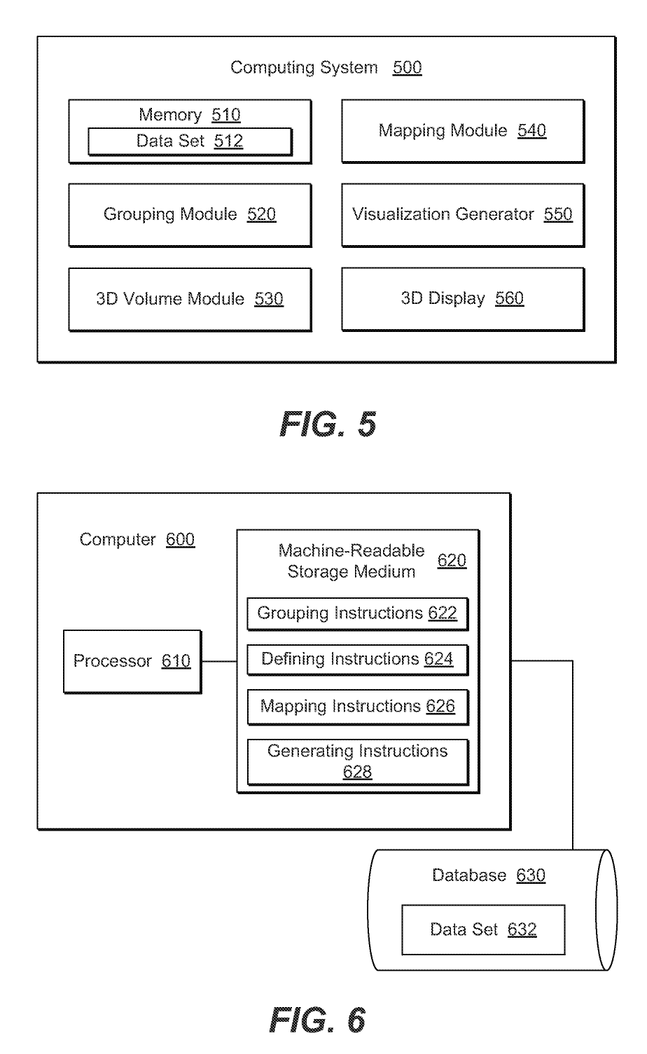

FIG. 5 illustrates a system for generating a 3D data visualization using disparity as a display variable, according to an example. Computing system 500 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 500 may include one or more machine-readable storage media separate from the one or more controllers, such as memory 510.

Computing system 500 may include memory 510, grouping module 520, 3D volume module 530, mapping module 540, visualization generator 550, and 3D display 560. Each of these components may be implemented by a single computer or multiple computers. The components may include software, one or more machine-readable media for storing the software, and one or more processors for executing the software. Software may be a computer program comprising machine-executable instructions.

in addition, users of computing system 500 may interact with computing system 500 through one or more other computers, which may or may not be considered part of computing system 500. As an example, a user may interact with system 500 via a computer application residing on system 500 or on another computer, such as a desktop computer, workstation computer, tablet computer, or the like. The computer application can include a user interface (e.g., touch interface, mouse, keyboard, gesture input device).

Computer system 500 may perform methods 100-300, and variations thereof, and components 520-560 may be configured to perform various portions of methods 100-300, and variations thereof. Additionally, the functionality implemented by components 520-560 may be part of a larger software platform, system, application, or the like. For example, these components may be part of a data analysis system.

in an example, memory 510 may be configured to store a data set 512 including multi-dimensional data. Grouping module 520 may be configured to group the data set into multiple groups based on a function of at least one variable of the multi-dimensional data, 3D volume module 530 may be configured to generate a 3D volume for each group based on dimensionality limits of data members within each group. Mapping module 540 may be configured to map data members in each group to the group's corresponding 3D volume using spatial display variables and other display variables. Mapping module may map a value of the function for each data member to at least one of the spatial display variables representing depth. Visualization generator 550 may be configured to generate a 3D data visualization comprising the 3D volumes. 3D display 560 may be configured to display the 3D data visualization.

Visualization generator 550 may be further configured to define a position and relative size of each 3D volume in an available 3D coordinate space based at least on constraints associated with 3D display 560. Visualization generator 550 may also be configured to generate left-right image pairs of the 3D volumes in accordance with the available 3D coordinate space to yield two views. The two views may form a stereoscopic binocular pair. Accordingly, the groups may be perceivable as clusters at different depths in the visualization due to the influence of the at least one of the spatial display variables representing depth.

FIG. 6 illustrates a computer-readable medium for generating a 3D data visualization using disparity as a display variable, according to an example. Computer 600 may be any of a variety of computing devices or systems, such as described with respect to computing system 500.

Computer 600 may have access to database 630. Database 630 may include one or more computers, and may include one or more controllers and machine-readable storage mediums, as described herein. Computer 600 may be connected to database 630 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 610 may be at least one central processing unit (CPU), at least one semiconductor-based microprocessor, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may fetch, decode, and execute instructions 622-628 among others, to implement various processing, As an alternative or in addition to retrieving and executing instructions, processor 610 may include at least one integrated circuit (IC), other control logic, other electronic circuits, or combinations thereof that include a number of electronic components for performing the functionality of instructions 622-628. Accordingly, processor 610 may be implemented across multiple processing units and instructions 622-628 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions for managing processing elements.

The instructions 622-628 when executed by processor 610 (e.g., via one processing element or multiple processing elements of the processor) can cause processor 610 to perform processes, for example, methods 100-300, and variations thereof. Furthermore, computer 600 may be similar to computing system 500 and may have similar functionality and be used in similar ways, as described above.

For example, grouping instructions 622 may cause processor 610 to group a data set comprising multi-dimensional data into multiple groups based on a function of at least one variable of the multi-dimensional data. Defining instructions 624 may cause processor 510 to define multiple 3D volumes corresponding to the multiple groups using spatial display variables. Mapping instructions 626 can cause processor 610 to, for each group, map data members from the group to graphic elements in a respective one of the 3D volumes using the spatial display variables and other display variables. A value of the function for each data member may be mapped to at least one of the spatial display variables representing depth. Generating instructions 626 can cause processor 610 to generate a 3D data visualization comprising the 3D volumes. The 3D data visualization may comprise left-right image pairs of the 3D volumes in accordance with an available 3D coordinate space to yield two stereoscopic binocular views. Accordingly, the groups may be perceivable as clusters at different depths in the visualization due to the influence of the at least one of the spatial display variables representing depth.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method of generating a three-dimensional (3D) data visualization from multi-dimensional data, the method comprising, by a computer system:
given a data set comprising multi-dimensional data, defining multiple groups of the data set based on a function of at least one variable of the multi-dimensional data;
defining multiple 3D volumes corresponding to the multiple groups;
for each 3D volume, generating graphic elements from the data members of the corresponding group using spatial display variables and other display variables, wherein a value of the function for each data member is mapped to at least one of the spatial display variables representing depth; and
generating a 3D data visualization comprising the 3D volumes and corresponding graphic elements.

2. The method of claim 1, wherein generating the 3D data visualization comprises:
defining a position and relative size of each 3D volume in an available 3D coordinate space; and
generating left-right image pairs of the 3D volumes in accordance with the available 3D coordinate space to yield two stereoscopic binocular views.

3. The method of claim 2, wherein defining a position and relative size of each 3D volume in an available 3D coordinate space comprises determining an optimal amount of disparity to include for the 3D volumes.

4. The method of claim 2 wherein defining the position of each 3D volume comprises correlating one or more coordinate positions of graphic elements between 3D volumes based on a common value of a variable.

5. The method of claim 4, wherein a relative origin of one 3D volume differs from a relative origin of another 3D volume.

6. The method of claim 4, wherein the available 3D coordinate space is based on constraints associated with a 3D display system, the constraints relating to at least one of perceivable depth, visibility, and expected viewer position.

7. The method of claim 1, further comprising:
determining that at least one of the groups is more important than the remaining groups,
wherein defining the position of each 3D volume comprises assigning a depth in the 3D data visualization closer to an expected position of a viewer to the at least one of the groups determined to be more important via the at least one of the spatial display variables representing depth.

8. The method of claim 1, wherein the spatial display variables comprise an x coordinate position, a y coordinate position, and a z coordinate position.

9. The method of claim 8, wherein the other display variables comprise one or more of orientation, shape, color, size, and connections between graphic elements, the connections between graphic elements being variable in length, thickness, color, position, or orientation.

10. The method of claim 1, further comprising displaying the 3D data visualization via a 3D display system.

11. A system for generating a three-dimensional (3D) data visualization from multi-dimensional data, the system comprising:
a grouping module to group a data set comprising multi-dimensional data into multiple groups based on a function of at least one variable of the multi-dimensional data;
a 3D volume module to generate a 3D volume for each group based on dimensionality limits of data members within each group;
a mapping module to map data members in each group to the group's corresponding 3D volume using spatial display variables and other display variables to yield a plurality of graphic elements, the mapping module configured to map a value of the function for each data member to at least one of the spatial display variables representing depth; and
a visualization generator to generate a 3D data visualization comprising the 3D volumes.

12. The system of claim 11, further comprising a 3D display to display the 3D data visualization.

13. The system of claim 12, wherein the visualization generator configured to define a position and relative size of each 3D volume in an available 3D coordinate space based at least on constraints associated with the 3D display.

14. The system of claim 13, wherein the visualization generator is configured to generate left-right image pairs of the 3D volumes in accordance with the available 3D coordinate space to yield two views forming a stereoscopic binocular pair such that the groups are perceivable as clusters at different depths in the visualization due to the influence of the at least one of the spatial display variables representing depth.

15. A non-transitory computer-readable storage medium storing instructions for execution by a system for generating a three-dimensional (3D) data visualization from multi-dimensional data, the instructions when executed causing the system to:
group a data set comprising multi-dimensional data into multiple groups based on a function of at least one variable of the multi-dimensional data;
define multiple 3D volumes corresponding to the multiple groups;
for each group, map data members from the group to graphic elements in a respective one of the 3D volumes using spatial display variables and other display variables, wherein a value of the function for each data member is mapped to at least one of the spatial display variables representing depth; and
generate a 3D data visualization comprising the 3D volumes, the 3D data visualization comprising left-right image pairs of the 3D volumes in accordance with an available 3D coordinate space to yield two stereoscopic binocular views such that the groups are perceivable as clusters at different depths in the visualization due to the influence of the at least one of the spatial display variables representing depth.
